(19) United States
(12) Patent Application Publication
(10) Pub. No.: US 2007/0269247 A1
(43) Pub. Date: Nov. 22, 2007

(54) Cartridge case

(75) Inventor: Zenko Motoki, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/512,459

(22) Filed: Aug. 29, 2006

(30) Foreign Application Priority Data
May 22, 2006 (JP) 2006-141510

(51) Int. Cl. B41J 17/32

(52) U.S. Cl. 400/208

(57) ABSTRACT

A first case component includes a first drive-side sidewall and a first support-side sidewall. A second case component includes a second drive-side sidewall and a second support-side sidewall. Each sidewall has a feed portion and a take-up portion. The feed portions and the take-up portions of the sidewalls in each case component are provided with male engagement claws that are projected from the edges of the sidewalls towards the opposing case component, and are also provided with female engagement claws which are disposed inward of the edges of the sidewalls and are engageable to the corresponding male engagement claws of the opposing case component. Thus, the first case component and the second case component are detachably combined with each other at four sections by engaging the male engagement claws with the female engagement claws.

### BACKGROUND OF THE INVENTION

1. Field of the Invention

The present invention relates to cartridge cases, and particularly, to a cartridge case that houses an ink-sheet unit used in printers.

2. Description of the Related Art

As a typical printer that quickly performs printing on recording paper in a line-by-line fashion or page-by-page fashion, a line thermal printer is known. A line thermal printer includes a long thermal head having heater elements arranged in the width direction of recording paper. Such a line thermal printer has an ink-sheet cartridge installed therein, which includes a cartridge case that houses an ink-sheet unit.

An ink-sheet unit includes a long ink sheet having coloring regions coated with, for example, yellow ink, magenta ink, and cyan ink, a tubular feed bobbin around which the ink sheet is wound from one end thereof, and a tubular take-up bobbin around which the ink sheet is wound from the other end thereof.

The cartridge case includes a top wall facing a top face of the ink-sheet unit, a bottom wall facing a bottom face of the ink-sheet unit, a drive-side sidewall located at a position facing drive shafts disposed at first ends of the feed bobbin and the take-up bobbin, and a support-side sidewall located at a position facing support shafts disposed at second ends of the feed bobbin and the take-up bobbin. The cartridge case includes a first case component and a second case component, which are composed of, for example, synthetic resin. The two case components are joined to each other by, for example, ultrasonic welding.

Japanese Unexamined Patent Application Publication No. 5-155122 discloses an example of the ink-sheet cartridge described above, in which the cartridge case houses the ink-sheet unit in a rotatable fashion with the feed bobbin and the take-up bobbin serving as shafts.

However, in the cartridge case included in the ink-sheet cartridge of the known example described above, since the first case component and the second case component are joined to each other by, for example, ultrasonic welding, the cartridge case has to be dismantled in order to replace a used ink sheet unit with a new one. The reusability of the cartridge case is thus extremely difficult, which prevents effective utilization of resources. In addition, this leads to an increase in cost of the ink-sheet cartridge.

### SUMMARY OF THE INVENTION

Accordingly, it is an object of the present invention to provide a reusable cartridge case that allows for an easy replacement of an ink-sheet unit so as to achieve effective utilization of resources.

The present invention provides a cartridge case that houses a detachable ink-sheet unit, the ink-sheet unit including a feed bobbin around which an ink sheet is wound from one end thereof and a take-up bobbin around which the ink sheet is wound from the other end thereof. The cartridge case includes a first case component and a second case component that are detachable with respect to each other. The first case component includes a bottom wall facing a bottom face of the ink-sheet unit, a first drive-side sidewall extending from one side of the bottom wall, and a first support-side sidewall extending from the other side of the bottom wall, the first drive-side sidewall facing first portions of drive shafts disposed at first ends of the feed bobbin and the take-up bobbin, the first support-side sidewall facing first portions of support shafts disposed at second ends of the feed bobbin and the take-up bobbin. The second case component includes a top wall facing a top face of the ink-sheet unit, a second drive-side sidewall extending from one side of the top wall, and a second support-side sidewall extending from the other side of the top wall, the second drive-side sidewall facing second portions of the drive shafts disposed at the first ends of the feed bobbin and the take-up bobbin, the second support-side sidewall facing second portions of the support shafts disposed at the second ends of the feed bobbin and the take-up bobbin. The first drive-side sidewall and the second drive-side sidewall each have a first portion proximate to the feed bobbin and a second portion proximate to the take-up bobbin. The first portions of the two drive-side sidewalls are provided with a pair of engagement claws, and the second portions of the two drive-side sidewalls are also provided with a pair of engagement claws. The first support-side sidewall and the second support-side sidewall each have a first portion proximate to the feed bobbin and a second portion proximate to the take-up bobbin. The first portions of the two support-side sidewalls are provided with a pair of engagement claws, and the second portions of the two support-side sidewalls are also provided with a pair of engagement claws. The first and second case components are combined with each other by means of the pairs of engagement claws.

According to the cartridge case of the present invention, the first case component and the second case component can be readily and securely combined with each other by means of the engagement claws. In addition, the cartridge case can be readily disassembled into the first case component and the second case component by simply disengaging the engagement claws.

Furthermore, in the cartridge case according to the present invention, each pair of engagement claws may include a male engagement claw and a female engagement claw engageable to the male engagement claw, the male engagement claw being projected from an edge of the corresponding sidewall in one of the case components towards the other case component when the case components are combined, the female engagement claw being disposed inward of an edge of the corresponding sidewall in the other case component. In each case component, every two engagement claws that face each other in a direction in which the corresponding drive-side sidewall and the corresponding support-side sidewall face each other are preferably defined by one of the male engagement claws and one of the female engagement claws, or every two engagement claws that are adjacent to each other in a direction in which the feed bobbin and the take-up bobbin are arranged are preferably defined by one of the male engagement claws and one of the female engagement claws.

Accordingly, the first case component and the second case component can be securely combined with each other.

As described above, according to the cartridge case of the present invention, the first case component and the second case component can be securely combined with each other, and the cartridge case can be readily disassembled into the first case component and the second case component so that the ink-sheet unit housed within the cartridge case is easily replaceable. Accordingly, the cartridge case is reusable, thereby achieving effective utilization of resources and reduced operating cost.

### BRIEF DESCRIPTION OF THE DRAWINGS

FIG. 1 is an exploded perspective view of an ink-sheet cartridge equipped with a cartridge case according to the present invention;

FIG. 2 is a bottom view of the ink-sheet cartridge shown in FIG. 1;

FIG. 3 is a cross-sectional view of the ink-sheet cartridge taken along line III-III in FIG. 2;

FIG. 4 is a cross-sectional view of the ink-sheet cartridge taken along line IV-IV in FIG. 2;

FIG. 5 is a cross-sectional view of the ink-sheet cartridge taken along line V-V in FIG. 2; and

FIG. 6 is a cross-sectional view showing an engagement state of a first engagement claw and a second engagement claw included in the cartridge case shown in FIG. 1.

### DESCRIPTION OF THE PREFERRED EMBODIMENTS

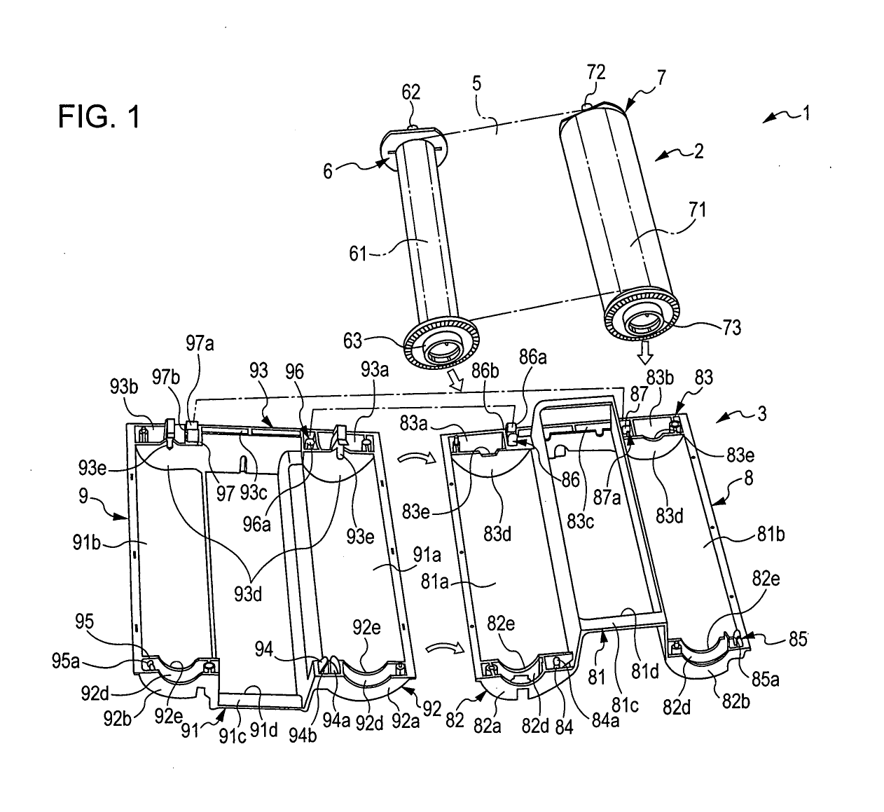

An ink-sheet cartridge equipped with a cartridge case according to an exemplary embodiment of the present invention will now be described with reference to FIGS. 1 to 6.

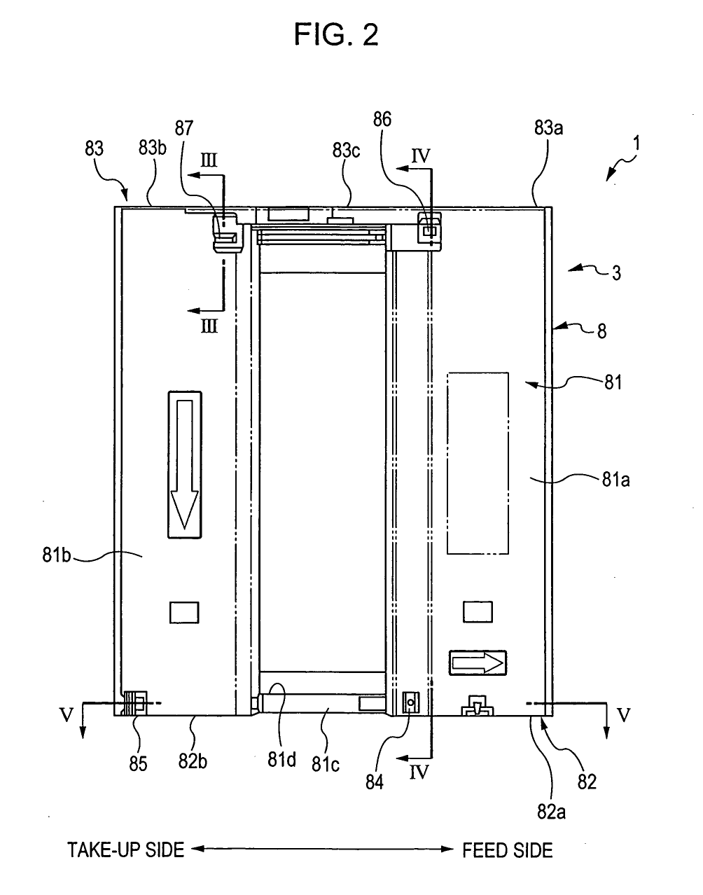

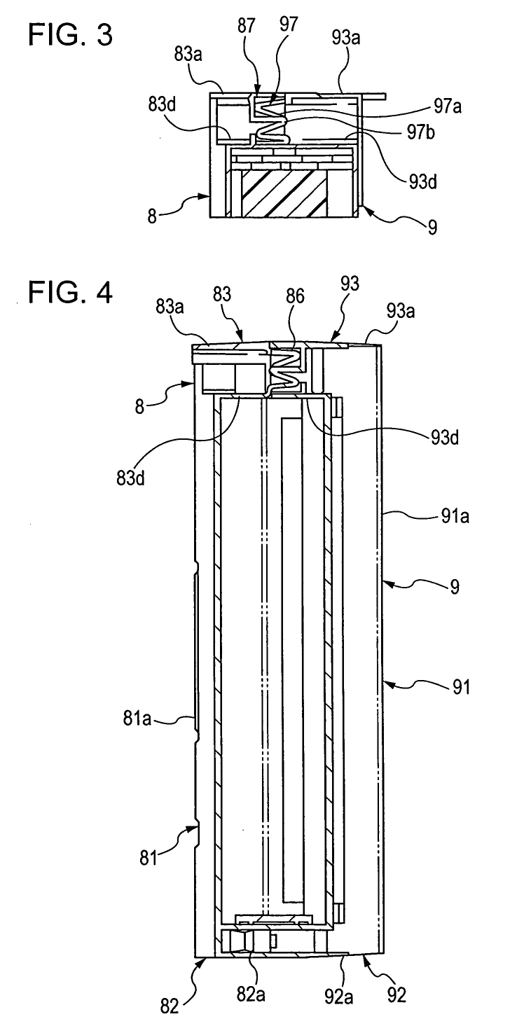

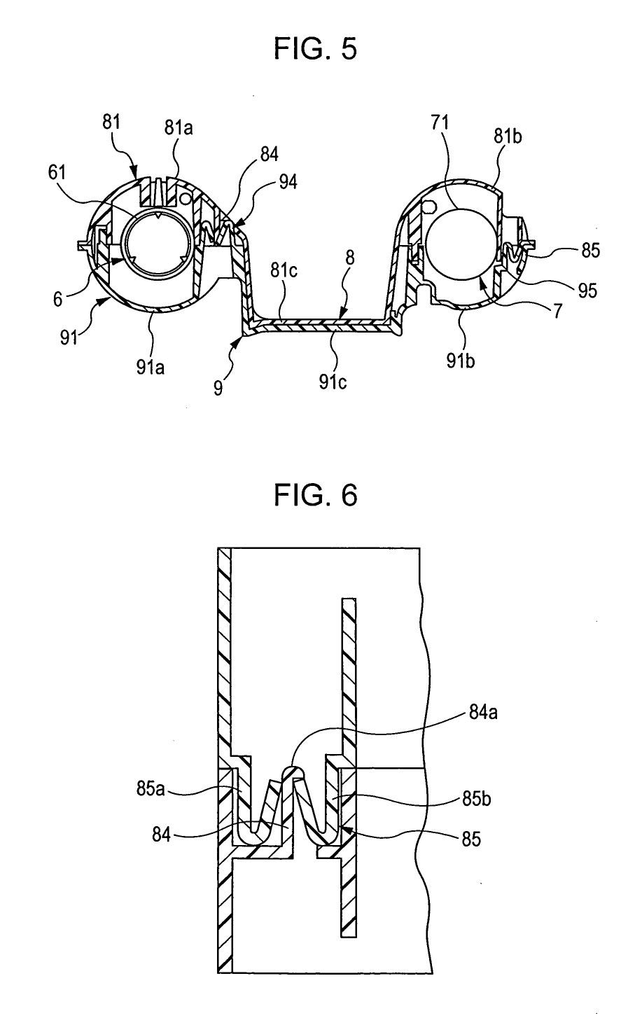

FIG. 1 is an exploded perspective view of an ink-sheet cartridge 1 according to this embodiment. FIG. 2 is a bottom view of the ink-sheet cartridge 1 shown in FIG. 1. FIG. 3 is a cross-sectional view of the ink-sheet cartridge 1 taken along line III-III in FIG. 2. FIG. 4 is a cross-sectional view of the ink-sheet cartridge 1 taken along line IV-IV in FIG. 2. FIG. 5 is a cross-sectional view of the ink-sheet cartridge 1 taken along line V-V in FIG. 2.

Referring to FIGS. 1 to 5, the ink-sheet cartridge 1 according to this embodiment includes an ink-sheet unit 2 and a cartridge case 3 housing the ink-sheet unit 2 in a detachable fashion.

The ink-sheet unit 2 includes a long ink sheet 5 having coloring regions coated with yellow (Y) ink, magenta (M) ink, and cyan (C) ink in a predetermined order, a feed bobbin 6 around which the ink sheet 5 is wound from one end thereof, and a take-up bobbin 7 around which the ink sheet 5 is wound from the other end thereof.

The feed bobbin 6 and the take-up bobbin 7 in the ink-sheet unit 2 are defined by substantially cylindrical components composed of resin and respectively include tubular base portions 61, 71 disposed at the waist sections thereof, drive shafts 63, 73 disposed at first ends of the base portions 61, 71, and support shafts 62, 72 disposed at second ends of the base portions 61, 71. The drive shafts 63, 73 have a diameter that is larger than the external diameter of the base portions 61, 71. On the other hand, the support shafts 62, 72 have a diameter that is smaller than the external diameter of the base portions 61, 71.

An unused portion of the ink sheet 5 is wound around the base portion 61 of the feed bobbin 6 from one end of the ink sheet 5. The base portion 71 of the take-up bobbin 7 takes up the ink sheet 5 from the other end thereof. The drive shafts 63, 73 are connected to a printer driving system (not shown) that applies a rotational driving force to the feed bobbin 6 and the take-up bobbin 7. Thus, the rotational driving force is transmitted to the feed bobbin 6 and the take-up bobbin 7 via the drive shafts 63, 73.

The cartridge case 3 includes a first resin case component 8 and a second resin case component 9 that can be combined with each other in a detachable fashion.

Referring to FIG. 1, the first case component 8 has a bottom wall 81 facing a bottom face of the ink-sheet unit 2, a first drive-side sidewall 82 extending vertically from one side of the bottom wall 81, and a first support-side sidewall 83 extending vertically from the other side of the bottom wall 81. Specifically, the first drive-side sidewall 82 is located at a position facing lower half portions of the drive shafts 63, 73 disposed at the first ends of the feed bobbin 6 and the take-up bobbin 7. Likewise, the first support-side sidewall 83 is located at a position facing lower half portions of the support shafts 62, 72 disposed at the second ends of the feed bobbin 6 and the take-up bobbin 7.

The bottom wall 81 includes a semi-cylindrical feed portion 81a at a position facing a bottom face of the portion of the ink sheet 5 wound around the feed bobbin 6, a semi-cylindrical take-up portion 81b at a position facing a bottom face of the portion of the ink sheet 5 wound around the take-up bobbin 7, and a link portion 81c that links the feed portion 81a and the take-up portion 81b. A midsection of the link portion 81c is provided with a window-like opening 81d through which the ink sheet 5 extending between the feed bobbin 6 and the take-up bobbin 7 is exposed.

The first drive-side sidewall 82 includes a semi-circular feed portion 82a at a position facing the drive shaft 63 of the feed bobbin 6, and a semi-circular take-up portion 82b at a position facing the drive shaft 73 of the take-up bobbin 7. The feed portion 82a and the take-up portion 82b have U-shaped cutouts on the edges thereof. The drive shafts 63, 73 are exposed through these cutouts. Furthermore, the first case component 8 includes inner walls 82d disposed at positions facing inner faces of the feed portion 82a and the take-up portion 82b of the first drive-side sidewall 82. The inner walls 82d are separated from the inner faces of the feed portion 82a and the take-up portion 82b by a predetermined gap and extend parallel to the inner faces. The inner walls 82d have U-shaped cutouts on the edges thereof, such that the cutouts serve as lower shaft bearings 82e for rotatably supporting the drive shafts 63, 73 of the feed bobbin 6 and the take-up bobbin 7.

The feed portion 82a and the take-up portion 82b of the first drive-side sidewall 82 are respectively provided with engagement claws 84, 85 used for detachably combining the first case component 8 and the second case component 9.

Referring to FIG. 6, the engagement claw 84 provided in the feed portion 82a of the first drive-side sidewall 82 is in the form of a leaf spring and is a female claw. The female engagement claw 84 is disposed within the gap between the feed portion 82a of the first drive-side sidewall 82 and the corresponding inner wall 82d, and is disposed inward of the first case component 8 from the edge of the first drive-side sidewall 82. Moreover, the female engagement claw 84 is oriented towards the second case component 9 when combined with the first case component 8, and has its end portion bent at a sharp angle towards the installed position of the take-up bobbin 7. This bent end portion defines an engagement segment 84a.

On the other hand, the engagement claw 85 provided in the take-up portion 82b of the first drive-side sidewall 82 is a male claw having a single claw segment 85a in the form of a leaf spring. The male engagement claw 85 is projected towards the second case component 9 when combined with the first case component 8. The claw segment 85a of the male engagement claw 85 has its end portion bent at a sharp angle towards the installed position of the feed bobbin 6 so as to form a V-shape.

The engagement claws 84, 85 and engagement claws 86, 87 (to be described below) of the first case component 8 are formed integrally with the first case component 8 using a resin material.

The first support-side sidewall 83 includes a feed portion 83a at a position facing the support shaft 62 of the feed bobbin 6, a take-up portion 83b at a position facing the support shaft 72 of the take-up bobbin 7, and a link portion 83c that links the feed portion 83a and the take-up portion 83b. Furthermore, the first case component 8 also includes semi-circular inner walls 83d disposed at positions facing inner faces of the feed portion 83a and the take-up portion 83b of the first support-side sidewall 83. The inner walls 83d are separated from the inner faces of the feed portion 83a and the take-up portion 83b by a predetermined gap and extend parallel to the inner faces. The inner walls 83d have U-shaped cutouts on the edges thereof, such that the cutouts serve as lower shaft bearings 83e for rotatably supporting the support shafts 62, 72 of the feed bobbin 6 and the take-up bobbin 7.

The feed portion 83a and the take-up portion 83b of the first support-side sidewall 83 are respectively provided with the engagement claws 86, 87 used for detachably combining the first case component 8 and the second case component 9.

The engagement claw 86 provided in the feed portion 83a of the first support-side sidewall 83 is a male claw having a pair of first and second claw segments 86a, 86b projected towards the second case component 9 when combined with the first case component 8. Of the two claw segments 86a, 86b, the first claw segment 86a is bent at a sharp angle towards the first drive-side sidewall 82 so as to form a V-shape. The second claw segment 86b is bent at a sharp angle towards the first claw segment 86a so as to form a V-shape. Thus, the claw segments 86a, 86b face each other.

On the other hand, the engagement claw 87 provided in the take-up portion 83b of the first support-side sidewall 83 is in the form of a leaf spring and is a female claw. The female engagement claw 87 is disposed within the gap between the take-up portion 83b of the first support-side sidewall 83 and the corresponding inner wall 83d, and is disposed inward of the first case component 8 from the edge of the first support-side sidewall 83. Moreover, the female engagement claw 87 is oriented towards the second case component 9 when combined with the first case component 8, and has its end portion bent at a sharp angle towards the first drive-side sidewall 82. This bent end portion defines an engagement segment 87a.

Referring to FIG. 1, the second case component 9 has a top wall 91 facing a top face of the ink-sheet unit 2, a second drive-side sidewall 92 extending vertically from one side of the top wall 91, and a second support-side sidewall 93 extending vertically from the other side of the top wall 91. Specifically, the second drive-side sidewall 92 is located at a position facing upper half portions of the drive shafts 63, 73 of the feed bobbin 6 and the take-up bobbin 7. Likewise, the second support-side sidewall 93 is located at a position facing upper half portions of the support shafts 62, 72 of the feed bobbin 6 and the take-up bobbin 7.

The top wall 91 includes a semi-cylindrical feed portion 91a at a position facing a top face of the portion of the ink sheet 5 wound around the feed bobbin 6, a semi-cylindrical take-up portion 91b at a position facing a top face of the portion of the ink sheet 5 wound around the take-up bobbin 7, and a link portion 91c that links the feed portion 91a and the take-up portion 91b. A midsection of the link portion 91c is provided with a window-like opening 91d through which the ink sheet 5 extending between the feed bobbin 6 and the take-up bobbin 7 is exposed.

The second drive-side sidewall 92 includes a semi-circular feed portion 92a at a position facing the drive shaft 63 of the feed bobbin 6, and a semi-circular take-up portion 92b at a position facing the drive shaft 73 of the take-up bobbin 7. The feed portion 92a and the take-up portion 92b have U-shaped cutouts on the edges thereof. The drive shafts 63, 73 are exposed through these cutouts. Furthermore, the second case component 9 also includes inner walls 92d disposed at positions facing inner faces of the feed portion 92a and the take-up portion 92b of the second drive-side sidewall 92. The inner walls 92d are separated from the inner faces of the feed portion 92a and the take-up portion 92b by a predetermined gap and extend parallel to the inner faces. The inner walls 92d have U-shaped cutouts on the edges thereof, such that the cutouts serve as upper shaft bearings 92e for rotatably supporting the drive shafts 63, 73 of the feed bobbin 6 and the take-up bobbin 7.

The feed portion 92a of the second drive-side sidewall 92 is provided with a male engagement claw 94 which faces the female engagement claw 84 in the feed portion 82a of the first drive-side sidewall 82 when the first case component 8 and the second case component 9 are disposed facing each other. The male engagement claw 94 has a pair of first and second claw segments 94a, 94b projected towards the first case component 8 when combined with the second case component 9. Of the two claw segments 94a, 94b, the first claw segment 94a is bent at a sharp angle towards the take-up side so as to form a V-shape. The second claw segment 94b is bent at a sharp angle towards the first claw segment 94a so as to form a V-shape. Thus, the claw segments 94a, 94b face each other.

The gap between the take-up portion 92b of the second drive-side sidewall 92 and the corresponding inner wall 92d contains a female engagement claw 95 which faces the male engagement claw 85 in the take-up portion 82b of the first drive-side sidewall 82 when the first case component 8 and the second case component 9 are disposed facing each other. The female engagement claw 95 is in the form of a leaf spring and is disposed inward of the second case component 9 from the edge of the second drive-side sidewall 92. Moreover, the female engagement claw 95 is oriented towards the first case component 8 when combined with the second case component 9, and has its end portion bent at a sharp angle in a direction opposite to the feed side. This bent end portion defines an engagement segment 95a.

The second support-side sidewall 93 includes a feed portion 93a at a position facing the support shaft 62 of the feed bobbin 6, a take-up portion 93b at a position facing the support shaft 72 of the take-up bobbin 7, and a link portion 93c that links the feed portion 93a and the take-up portion 93b. The feed portion 93a and the take-up portion 93b of the second support-side sidewall 93 have a double-walled structure. Furthermore, the second case component 9 also includes inner walls 93d disposed at positions facing inner faces of the feed portion 93a and the take-up portion 93b of the second support-side sidewall 93. The inner walls 93d are separated from the inner faces of the feed portion 93a and the take-up portion 93b by a predetermined gap and extend parallel to the inner faces. The inner walls 93d have U-shaped cutouts on the edges thereof, such that the cutouts serve as upper shaft bearings 93e for rotatably supporting the support shafts 62, 72 of the feed bobbin 6 and the take-up bobbin 7.

The gap between the feed portion 93a of the second support-side sidewall 93 and the corresponding inner wall 93d contains a female engagement claw 96 which faces the male engagement claw 86 in the feed portion 83a of the first support-side sidewall 83 when the first case component 8 and the second case component 9 are disposed facing each other. The female engagement claw 96 is in the form of a leaf spring and is disposed inward of the second case component 9 from the edge of the second support-side sidewall 93. Moreover, the female engagement claw 96 is oriented towards the first case component 8 when combined with the second case component 9, and has its end portion bent at a sharp angle towards the second support-side sidewall 93. This bent end portion defines an engagement segment 96a.

The take-up portion 93b of the second support-side sidewall 93 is provided with a male engagement claw 97 which faces the female engagement claw 87 in the take-up portion 83b of the first support-side sidewall 83 when the first case component 8 and the second case component 9 are disposed facing each other. The male engagement claw 97 has a pair of first and second claw segments 97a, 97b projected towards the first case component 8 when combined with the second case component 9. Of the two claw segments 97a, 97b, the first claw segment 97a is bent at a sharp angle towards the second drive-side sidewall 92 so as to form a V-shape. The second claw segment 97b is bent at a sharp angle towards the first claw segment 97a so as to form a V-shape. Thus, the claw segments 97a, 97b face each other.

The feed portion 91a of the top wall 91 has openings at positions corresponding to the male engagement claw 94 and the female engagement claw 96. The engagement claws 94, 96 are exposed through these openings. Furthermore, the take-up portion 91b of the top wall 91 has openings at positions corresponding to the female engagement claw 95 and the male engagement claw 97. The engagement claws 95, 97 are exposed through these openings.

The engagement claws 94, 95, 96, 97 of the second case component 9 are formed integrally with the second case component 9 using a resin material.

Consequently, in the first case component 8, every two engagement claws that face each other in a direction in which the first drive-side sidewall 82 and the first support-side sidewall 83 face each other are the female engagement claw 84 and the male engagement claw 86 or the male engagement claw 85 and the female engagement claw 87. Moreover, in the first case component 8, every two engagement claws that are adjacent to each other in a direction in which the feed bobbin 6 and the take-up bobbin 7 are arranged are the female engagement claw 84 and the male engagement claw 85 or the male engagement claw 86 and the female engagement claw 87. Likewise, in the second case component 9, every two engagement claws that face each other in a direction in which the second drive-side sidewall 92 and the second support-side sidewall 93 face each other are the male engagement claw 94 and the female engagement claw 96 or the female engagement claw 95 and the male engagement claw 97. Moreover, in the second case component 9, every two engagement claws that are adjacent to each other in a direction in which the feed bobbin 6 and the take-up bobbin 7 are arranged are the male engagement claw 94 and the female engagement claw 95 or the female engagement claw 96 and the male engagement claw 97.

The first case component 8 and the second case component 9 are combined with each other by engaging the engagement claws 84, 85, 86, 87 of the first drive-side sidewall 82 and the first support-side sidewall 83 respectively with the engagement claws 94, 95, 96, 97 of the second drive-side sidewall 92 and the second support-side sidewall 93.

The advantages of this embodiment will now be described.

When combining the first case component 8 and the second case component 9 of the cartridge case 3, the ink-sheet unit 2 is first set within the first case component 8. The first case component 8 is then disposed facing the second case component 9. At this time, the first drive-side sidewall 82 and the second drive-side sidewall 92 are disposed such that the female engagement claws 84, 95 face the male engagement claws 85, 94. Thus, the engagement segment 84a of the female engagement claw 84 is engaged to an end of the second claw segment 94b of the male engagement claw 94, and the engagement segment 95a of the female engagement claw 95 is engaged to an end of the claw segment 85a of the male engagement claw 85. Similarly, the first support-side sidewall 83 and the second support-side sidewall 93 are disposed such that the female engagement claws 87, 96 face the male engagement claws 86, 97. Thus, the engagement segment 96a of the female engagement claw 96 is engaged to an end of the second claw segment 86b of the male engagement claw 86, and the engagement segment 87a of the female engagement claw 87 is engaged to an end of the second claw segment 97b of the male engagement claw 97. Accordingly, the first case component 8 and the second case component 9 are combined.

On the other hand, when disassembling the cartridge case 3 into the first case component 8 and the second case component 9, the engagement segments 84a, 87a, 95a, 96a of the respective female engagement claws 84, 87, 95, 96 are disengaged from the claw segments 85a, 86b, 94b, 97b of the respective male engagement claws 85, 86, 94, 97.

According to this embodiment, the first case component 8 and the second case component 9 can be readily and securely combined with each other by engaging the four engagement claws 84, 85, 86, 87 provided in the first case component 8 respectively to the four engagement claws 94, 95, 96, 97 provided in the second case component 9. In addition, the cartridge case 3 can be readily disassembled into the first case component 8 and the second case component 9 by disengaging the engagement claws 84, 85, 86, 87 respectively from the engagement claws 94, 95, 96, 97.

Accordingly, the four engagement claws 84, 85, 94, 95 provided in the first case component 8 and the second case component 9 allows the first case component 8 and the second case component 9 to be securely combined with each other at four sections. In addition, the ink-sheet unit 2 housed within the cartridge case 3 is readily replaceable by simply disengaging the first case component 8 from the second case component 9. Consequently, the cartridge case 3 is reusable, thereby achieving effective utilization of resources and reduced operating cost.

Furthermore, as described above, in the first case component 8, every two engagement claws that face each other in a direction in which the first drive-side sidewall 82 and the first support-side sidewall 83 face each other are the female engagement claw 84 and the male engagement claw 86 or the male engagement claw 85 and the female engagement claw 87. Moreover, in the first case component 8, every two engagement claws that are adjacent to each other in a direction in which the feed bobbin 6 and the take-up bobbin 7 are arranged are the female engagement claw 84 and the male engagement claw 85 or the male engagement claw 86 and the female engagement claw 87. Likewise, in the second case component 9, every two engagement claws that face each other in a direction in which the second drive-side sidewall 92 and the second support-side sidewall 93 face each other are the male engagement claw 94 and the female engagement claw 96 or the female engagement claw 95 and the male engagement claw 97. Moreover, in the second case component 9, every two engagement claws that are adjacent to each other in a direction in which the feed bobbin 6 and the take-up bobbin 7 are arranged are the male engagement claw 94 and the female engagement claw 95 or the female engagement claw 96 and the male engagement claw 97. Consequently, this allows the first case component 8 and the second case component 9 to be securely combined with each other.

The technical scope of the present invention is not limited to the above embodiment, and modifications are permissible within the scope and spirit of the present invention.

For example, the shape of the engagement claws used for combining the first case component 8 and the second case component 9 is not limited to the shape described in the above embodiment and may be arbitrarily determined.

What is claimed is:

1. A cartridge case housing a detachable ink-sheet unit, the ink-sheet unit including a feed bobbin around which an ink sheet is wound from one end thereof and a take-up bobbin around which the ink sheet is wound from the other end thereof, the cartridge case comprising:
a first case component and a second case component that are detachable with respect to each other,
wherein the first case component includes a bottom wall facing a bottom face of the ink-sheet unit, a first drive-side sidewall extending from one side of the bottom wall, and a first support-side sidewall extending from the other side of the bottom wall, the first drive-side sidewall facing first portions of drive shafts disposed at first ends of the feed bobbin and the take-up bobbin, the first support-side sidewall facing first portions of support shafts disposed at second ends of the feed bobbin and the take-up bobbin,
wherein the second case component includes a top wall facing a top face of the ink-sheet unit, a second drive-side sidewall extending from one side of the top wall, and a second support-side sidewall extending from the other side of the top wall, the second drive-side sidewall facing second portions of the drive shafts disposed at the first ends of the feed bobbin and the take-up bobbin, the second support-side sidewall facing second portions of the support shafts disposed at the second ends of the feed bobbin and the take-up bobbin, and
wherein the first drive-side sidewall and the second drive-side sidewall each have a first portion proximate to the feed bobbin and a second portion proximate to the take-up bobbin, the first portions of the two drive-side sidewalls being provided with a pair of engagement claws, the second portions of the two drive-side sidewalls being provided with a pair of engagement claws, wherein the first support-side sidewall and the second support-side sidewall each have a first portion proximate to the feed bobbin and a second portion proximate to the take-up bobbin, the first portions of the two support-side sidewalls being provided with a pair of engagement claws, the second portions of the two support-side sidewalls being provided with a pair of engagement claws, and wherein the first and second case components are combined with each other by means of the pairs of engagement claws.

2. The cartridge case according to claim 1, wherein each pair of engagement claws comprises a male engagement claw and a female engagement claw engageable to the male engagement claw, the male engagement claw being projected from an edge of the corresponding sidewall in one of the case components towards the other case component when the case components are combined, the female engagement claw being disposed inward of an edge of the corresponding sidewall in said other case component, and
wherein, in each case component, every two engagement claws that face each other in a direction in which the corresponding drive-side sidewall and the corresponding support-side sidewall face each other comprises one of the male engagement claws and one of the female engagement claws, or every two engagement claws that are adjacent to each other in a direction in which the feed bobbin and the take-up bobbin are arranged comprises one of the male engagement claws and one of the female engagement claws.
